(19) United States
(12) Patent Application Publication
(10) Pub. No.: US 2005/0028667 A1
(43) Pub. Date: Feb. 10, 2005

(54) Foot operated tambourine playing device

(76) Inventor: Joe P. Navarro, Globe, AZ (US)

Correspondence Address: Joe P. Navarro, P. O. Box 2661, Globe, AZ, 85502, US

(21) Appl. No.: 10/628,143

(22) Filed: Jul. 28, 2003

(51) Int. Cl. G10D 13/02

(52) U.S. Cl. 84/418

(57) ABSTRACT

A foot operated tambourine playing device for playing the tambourine with the left or right foot. The foot operated tambourine playing device includes a Foot Clip, Steel hoop, foot pedal, nuts, pins, base for pedal and strap for shoe.

### BACKGROUND OF THE INVENTION

1. Field of the Invention

The present invention relates to foot operated musical devices and more particularly pertains to a new method of operating a tambourine playing device for playing the tambourine with either foot.

2. Description of the Prior Art

The use of foot operated musical devices is well known in the prior art. Specifically, foot operated musical devices devised and used are known to consist basically of familiar, expected and obvious structural configurations, notwithstanding the myriad of designs encompassed by the crowded prior art which have been developed for the completion and fulfillment of various and countless objectives and requirements.

Known prior art includes U.S. Pat. No. 2,475,542, U.S. Pat. No. 3,994,197, U.S. Pat. No. 3,481,239 and U.S. Pat. No. 6,096,957

While the above mentioned devices achieve their particular objectives and expectations, the above mentioned patents do not illustrate or disclose a foot operated tambourine that includes the unique method of attaching a removable strap to either the left or right shoe.

In these respects, the shoe-strap, foot operated tambourine playing device according to the present invention substantially departs from the concepts and designs of the prior art, and in so doing provides an apparatus primarily developed for the purpose of playing the tambourine with either foot.

### SUMMARY OF THE INVENTION

In view of the disadvantages inherent in the known types of foot operated musical devices now present in the prior art, the present invention provides a new and unique device construction wherein the same can be utilized for playing the tambourine with either foot by use of a removable strap.

The general purpose of the present invention is to provide the new operated tambourine playing device apparatus and method which has many advantages of the foot operated musical devices mentioned heretofore and many novel features that results in a new and unique foot operated tambourine playing device which is not anticipated, rendered obvious, suggested, or even implied by any of the prior art foot operated musical devices, either alone or in any combination thereof.

To attain this, the present invention generally comprises a heavy duty steel hoop, foot pedal with accompanying strap and folds for convenient storage.

There has thus been outlined, rather broadly, the more important features of the invention in order that the detailed description thereof follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those that are skilled in the art of musical instrument usage will appreciate that the conception, upon which this disclosure is based, may readily be utilized as a basis for designing of other methods, structures and systems for carrying out the several purposes of the present invention. It is important, therefore, that the claims be regarded as including such equivalent constructions insofar as they do not depart from the spirit and scope of the present invention.

The purpose of the foregoing abstract is to enable the U.S. Patent And Trademark Office and the public generally, and especially scientists, engineers and practitioners in the art who are not familiar with patent or legal terms or phraseology, to determine quickly from a cursory inspection the nature and essence of the technical disclosure of the application. The abstract is not intended to define the invention of the application, which is measured by the claims, nor is it intended to be limiting as to the scope of the invention in any way.

It is therefore an object of the present invention to provide a new and unique foot operated tambourine playing device apparatus and method which has many of the advantages of the foot operated musical devices mentioned heretofore and many novel features that result in a new and unique foot operated tambourine playing device that is not rendered obvious, anticipated, suggested, or even implied by any of the prior art foot operated musical devices, either alone or in any combination thereof.

It is another objective of the present invention to provide a new foot operated tambourine playing device which may be easily and efficiently manufactured and marketed.

It is a further objective of the present invention to provide a new foot operated tambourine which is of a durable and reliable construction.

An even further important object of the present invention is to provide a new foot operated tambourine playing device which is susceptible of a low cost to manufacture with regards to both materials and labor, and which accordingly is then susceptible of low prices of sale to the consuming public, thereby making such foot operated tambourine playing device economically available to the buying public.

Still another object of the present invention is to provide a new foot operated tambourine playing device for playing the tambourine with either foot by merely attaching the removable strap to either foot.

Still another object of the present invention is to provide a new foot operated tambourine playing device that permits the user to play more than one instrument at a time, such as, for example, a guitar and the tambourine. Thus a solo act has a fuller sound.

These together with other objects for the invention, along with the various features of novelty which characterize the invention, are pointed out in the claims annexed to and forming a part of this disclosure. For a better understanding of the invention, its operating advantages and the specific objects attained by its uses, reference should be made to the accompanying drawings and descriptive matter in which there are illustrated embodiments of the invention.

### DESCRIPTION OF THE PREFERRED EMBODIMENT

With reference now to the drawings, and in particular to Drawing #1 a new foot operating tambourine playing device encompasses the principles and concepts of the present invention and generally designated by the drawings included will be described below.

As best illustrated by Drawing #1 the foot operated tambourine consists of The Foot Pedal (plastic, nylon or metal alloy) which may be worn on either the left or right foot and will offer a feature to assist in holding the device to the performer's foot. The Attachment Hardware (which will utilize various materials such as but not limited to plastic, nylon, rubber, and metal alloys) which will feature means of adjusting the angle of the Tambourine relative to that of the Foot Pedal as illustrated by Drawing #3.

Also, the Attachment Hardware will also permit the Foot Pedal to be rotated to the inside diameter of the Tambourine for storage and transport. The Tambourine, which is similar in design to the traditional playing device but offers a more robust materials of construction, such as a heavier grade metal alloys. It also provides a means of affixing the Foot Pedal via the Attachment Hardware. See Drawing #3.

Further, the Attachment Hardware of the Tambourine will be adjusted to the desired angle. The user will place either the left or right toe area of the foot into the Foot Pedal. The Tambourine is played by tapping the foot up and down. After use the Foot Pedal can be rotated to the inside diameter of the Tambourine to allow for more convenient storage and transport.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operating shown and described, and accordingly, all suitable modifications and equivalents may be resorted to, falling within the scope of the invention.

### BRIEF DESCRIPTION OF THE DRAWINGS

The invention will be better understood and objects other than those set forth above will become apparent when consideration is given to the following detailed description thereof Such description makes reference to the drawings wherein:

FIG. 1: TOP VIEW NAVARRINO TAMBOURINE

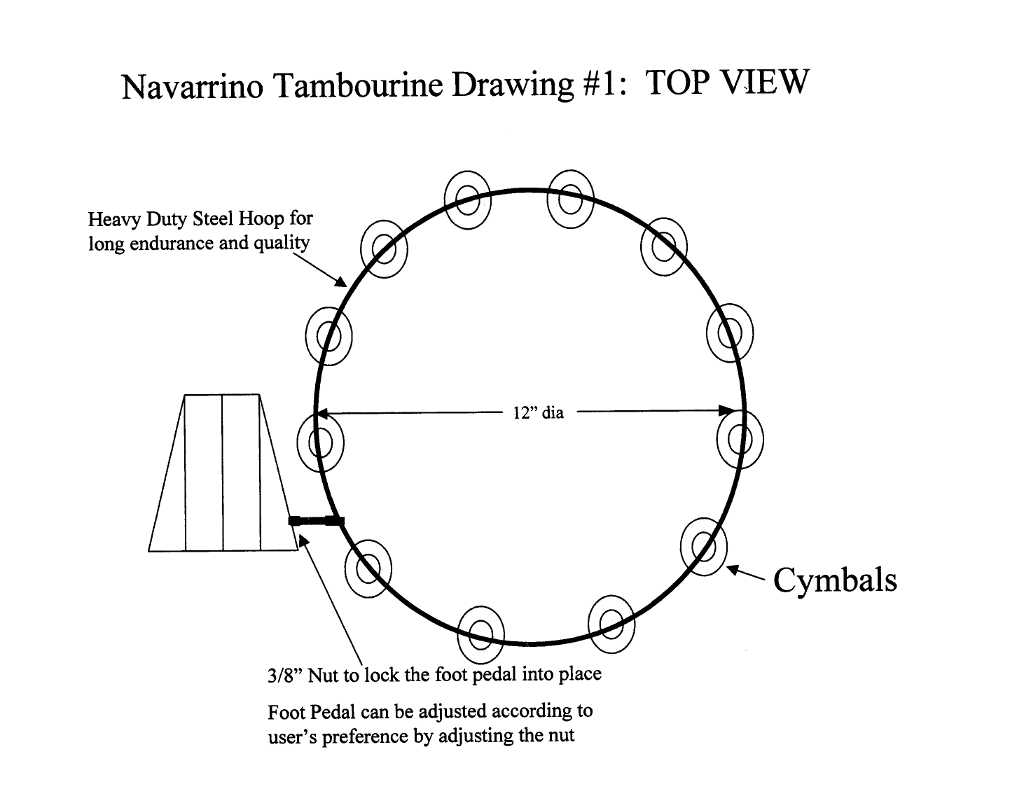

FIG. 2 SIDE VIEW NAVARRINO TAMBOURINE

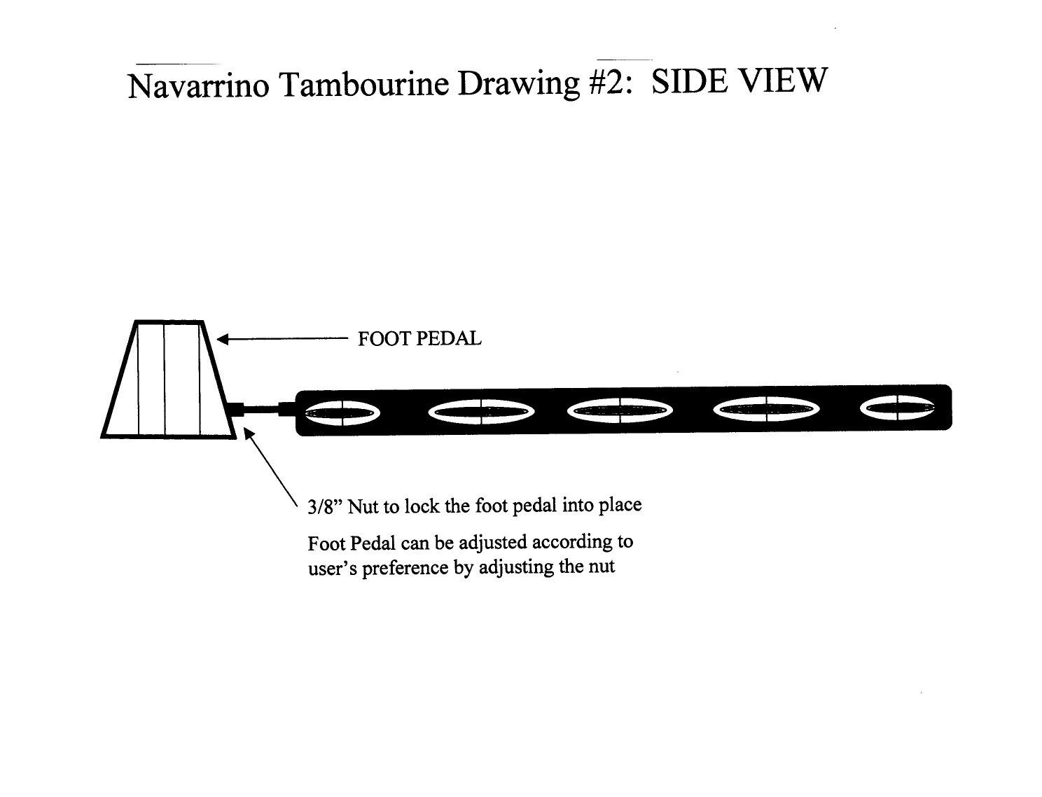

FIG. 3 ANGLE PEDAL BASE

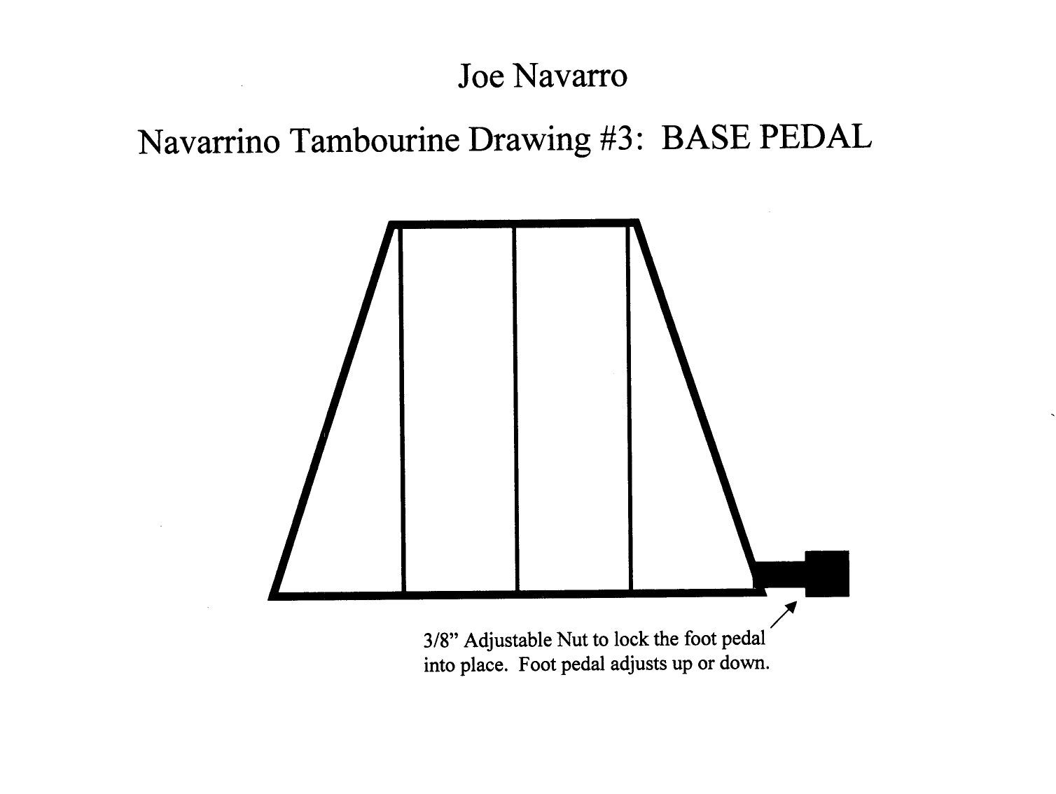

1. A unique foot operated device for playing a tambourine, consisting of:

2. A foot pedal pivotally situated to the tambourine that is coupled to the side of the tambourine base that is generally perpendicular to the tambourine casing.

3. The foot operated device of claim 1, wherein the foot pedal has a resiliently stable pad extending downwardly there from, said pedal pad being extended above the ground surface.

4. The foot operated device of claim 1, is suspended from the ground surface via the adjustable foot strap that is movable from left or right foot.

5. The foot operated device of claim 1, is attached to the tambourine playing device by a ⅜″ nut to lock that is adjustable to the user's pressure requirements.

6. A foot operated musical instrument, comprising:
Adjustable Strap
Accompanying hardware
A tambourine coupled to the lower surface of the foot strap.
A foot pedal coupled with the adjustable strap on a hinge pin on 90 degree angle to put in slot and lock in.
